(19) United States
(12) Patent Application Publication
(10) Pub. No.: US 2022/0408687 A1
(43) Pub. Date: Dec. 29, 2022

(54) MODULAR ANIMAL CUSHION

(71) Applicant: DogGoneGood LLC, Colorado Springs, CO (US)

(72) Inventor: Susan Marie Heath, Colorado Springs, CO (US)

(73) Assignee: DogGoneGood LLC, Colorado Springs, CO (US)

(21) Appl. No.: 17/806,973

(22) Filed: Jun. 15, 2022

Related U.S. Application Data
(60) Provisional application No. 63/213,904, filed on Jun. 23, 2021.

(51) Int. Cl. A01K 1/035

(52) U.S. Cl. CPC A01K 1/0353

(57) ABSTRACT

A modular inflatable pet bed includes a washable, detachable cover secured to the bed by a set of dual hook connectors. The modular pet bed is comprised of an inflatable core that is impervious to fluids and resistant to puncture. The underlying supportive bed is substantially a rectangular cuboid having an upper and lower surface separated by a width. At each of the 4 vertices associated with the lower surface exists a grommet through which a first portion of a dual hook connector is engaged. The complementary or second portion of the dual hook connector engages a corresponding grommet in a corner of the overlying cover. Upon securing the four corners of the cover to the lower portion of the supportive base, the cover forms an absorbent, washable barrier on which the pet may comfortably rest.

### RELATED APPLICATION

The present application relates to and claims the benefit of priority to U.S. Provisional Patent Application No. 63/213,904 filed 23 Jun. 2021, which is hereby incorporated by reference in its entirety for all purposes as if fully set forth herein.

### BACKGROUND OF THE INVENTION

### Field of the Invention

Embodiments of the present invention relate, in general, to animal cushions and more particularly to a modular animal cushion system.

### Relevant Background

Household pets are common. Indeed, it is estimated that 67% of U.S. Households, or about 85 million families, own a pet. Many of these pets are cats and dogs and sleeping accommodations are often a challenge. Not that a pet can't find a comfortable place to sleep but rather convincing the pet to adopt the homeowner's desired sleeping location. And once that location is adopted by the pet the challenge of keeping the location clean becomes a priority. Many current pet beds possess removable covers to aid in the cleaning process. Removing these covers from the bed made to accommodate a large dog is no easy task. Current covers are generally fitted very tight around the bed often secured with a zipper or the like. Then, with the cover finally removed, the permeable fabric allows the dirt, oil from the dog's coat, drool and other bodily fluids to penetrate the cover into the bed itself. And in most instances, the bed itself is not machine (or even non-machine) washable. As one might imagine, odor and the bacteria are ever present even when the cover can be cleaned.

Pet beds need to be cleaned regularly, and many pet care sites recommend that beds are cleansed on a weekly basis. Give the difficulty, this task is often overlooked resulting in an environment less than healthy or enticing to the pet not to mention the air quality surrounding such an environment for others living in the household.

A common alternative is the use of old quilts and blankets; the concept being aligned with a disposable bedding approach. Most dogs love quilts because dogs love to dig. Many eviscerate these quilts to their eventual satisfaction using their paws and claws to accomplish “the dig” and settle in as if they'd achieved nirvana. However, the perpetual digging leaves holes in the quilts which provided another source of joyous activity for the dogs as they pulled the oodles and oodles of poly batting from the quilts like magicians with their endless colored scarves.

What is needed is a pet bed that can be easily cleaned while retaining its ability to provide a comfortable resting place for household animals. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

A sturdy, inflatable pet bed with a reversible fabric coverlet that attaches to the four corners of the bed with double ended metal snaps or precisely plated trigger (hooks) clips is hereafter describe by way of example. According to one embodiment of the present invention, grommets are placed at each of the four corners of the coverlet aligned with corresponding grommets on the bed. One end of the trigger clip attaches to the fabric's grommet, the other to the manufactured hole in the bed securing the cover the bed. As the interior portion of the bed inflates and deflates it can be used anywhere in the home, stowed easily for air or boat travel, and/or camping. And as the cover becomes soiled it can be easily removed, cleaned, and returned to the bed with minimal effort.

One embodiment of a modular pet cushion system according to the present invention includes a supportive base encased with a protective sheath configured to be puncture resistant and impervious to fluids. The supportive base is substantially a rectangular cuboid having a width and an upper and lower surface. Of the eight vertices associated rectangular cuboid shape, each of the four associated with the lower surface include a base grommet.

The modular pet cushion system also includes a cover overlaying the supportive base. The cover has four corners and includes a central portion sized to substantially match the upper surface of the supportive base along with elongated portions at each corner. Within the elongated portions is a cover grommet. Lastly the modular pet cushion system includes a set of attachment devices configured to connect each lower surface grommet with a cover grommet at each corner of the cover thereby removably securing the cover to the supportive base covering its upper surface.

In one version of the present invention the supportive base modular pet cushion system is inflatable and in another version the support base is self-inflatable. As the supportive base holds a volume of air it includes an inflation valve, and in other versions a pressure release value to protect from rupture due to over pressurization.

The supportive base of modular pet cushion system can include internal baffles to aid in the structure compressibility and stability of the base as well as include in another version of the invention, internal viscoelastic polyurethane foam. The supportive base may also include, in another embodiment, a thermoplastic polyurethane core.

The cover of the modular pet cushion system is absorbent in one version of the invention and may be disposable and/or washable in other versions. The cover can also be reversible to aid in its versatility and to increase the time interval between cleanings.

The cover is attached to the supportive base, according to one embodiment of the present invention using an attachment device, wherein each attachment device has a first movable attachment latch and second movable attachment latch separated by a connector. Each attachment device is configured to link the cover to the lower surface of the supportive base by a distance less than the width of the supportive base.

In another version of the present invention, the modular pet cushion is presented as kit, comprising an inflatable supportive base encased with a protective sheath configured to be puncture resistant and impervious to fluids, a cover, a set of attachment devices, and a pump.

The supportive base is substantially an inflatable rectangular cuboid having an upper surface, a width, a lower surface and eight vertices, wherein each vertex associated the lower surface includes a base grommet. The supportive base includes an inflation valve. The cover has four corners and includes a central portion, sized to substantially match the upper surface of the supportive base, and elongated portions at each corner. Each elongated portion includes a cover grommet.

The attachment devices are each configured to connect each lower surface grommet with a cover grommet at each corner of the cover thereby removably securing the cover to the supportive base. Finally, the pump is configured to detachably couple with the inflation value of the supportive base and inflate the supportive base to a predefined pressure.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1A shows a perspective view of a modular pet cushion system according to one embodiment of the present invention.

FIGS. 1B-1D show a side cutaway views of the modular pet cushion system of FIG. 1A.

FIG. 2 shows a front view of a modular pet cushion system according to one embodiment of the present invention.

FIG. 3 shows a back view of a modular pet cushion system according to one embodiment of the present invention.

FIG. 4 shows a right-side view of a modular pet cushion system according to one embodiment of the present invention.

FIG. 5 shows a left-side view of a modular pet cushion system according to one embodiment of the present invention.

FIG. 6 shows a top view of a modular pet cushion system according to one embodiment of the present invention.

FIG. 7 shows a bottom view of a modular pet cushion system according to one embodiment of the present invention

FIG. 8 shows an exploded, perspective view of a modular pet cushion system according to one embodiment of the present invention.

FIG. 9 shows a top view of one version of a cover for a modular pet cushion system overlaying an underlying supportive base according to one embodiment of the present invention.

FIG. 10 shows a top view of a second version of a cover for of a modular pet cushion system overlaying an underlying supportive base according to one embodiment of the present invention.

FIG. 11 is an expanded view of one corner of an attachment device connecting the cover to the lower surface of the supportive base according to one embodiment of the present invention.

FIG. 12 shows a top view of one version of a cover for a modular pet cushion system overlaying lying flat according to one embodiment of the present invention.

FIG. 13 shows a top view of a second version of a cover for of a modular pet cushion system overlaying lying flat according to one embodiment of the present invention.

The Figures depict embodiments of the present invention for purposes of illustration only. Like numbers refer to like elements throughout. In the figures, the sizes of certain lines, layers, components, elements or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

A modular inflatable pet bed includes a washable, detachable cover secured to the bed by a set of dual hook connectors. The modular pet bed of the present invention is comprised of an inflatable core that is impervious to fluids and resistant to puncture. The underlying supportive bed is, in one embodiment, a rectangular cuboid having an upper and lower surface separated by a width. At each of the 4 vertices associated with the lower surface exists a grommet through which a first portion of a dual hook connector is engaged. The complementary or second portion of the dual hook connector engages a corresponding grommet in a corner of the overlying cover. Upon securing the four corners of the cover to the lower portion of the supportive base, the cover forms an absorbent, washable barrier on which the pet may comfortably rest.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

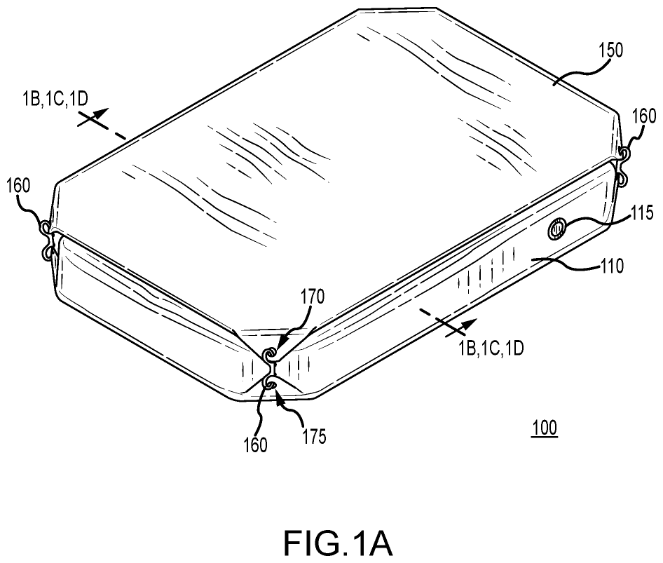

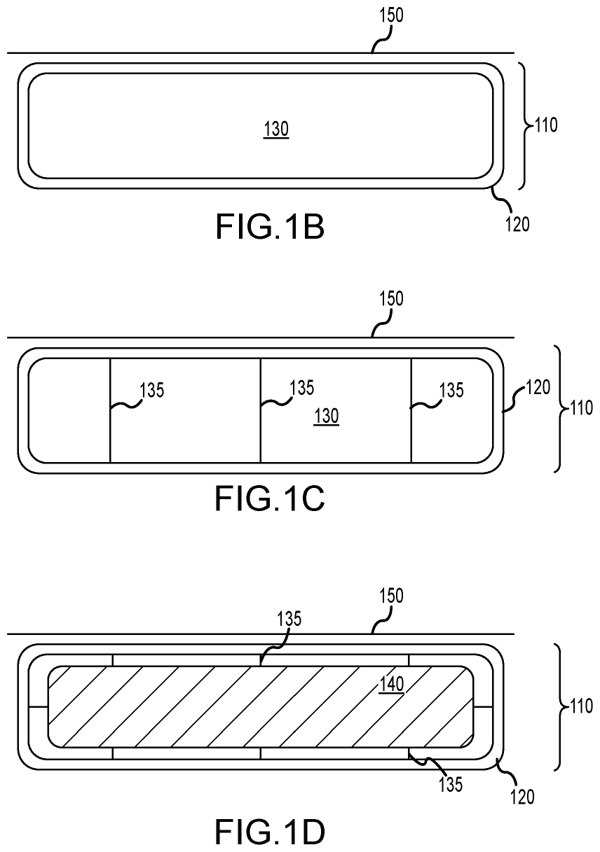

FIG. 1A presents a prospective view of one embodiment of an inventive modular pet bed 100 with FIGS. 1B-D providing a cut away rendition. A supportive base 110 is encased with a protective sheath 120 that is puncture resistant and impervious to fluids. The supportive base 110 is, in one embodiment, substantially a rectangular cuboid having an upper surface, a width, a lower surface and eight vertices. In other embodiments the supportive base 110 may be oval or circular in shape. In yet other versions of the present invention the based may a variety of shapes suitable for an animal's size and species.

The supportive base 110 is, in a preferred embodiment, inflatable, impervious to fluids and resistant to punctures. In one version of the invention, the supportive base 110 is formed from two components. An inner core 130 is an inflatable structure having a substantially rectangular cuboid. The core 130 is thereafter encased with a protective sheath 120 that is both impervious to fluids and puncture resistant. The two can be bonded together forming a single component of the modular system or in other embodiments the inner core 130 may be configured within the sheath 120 and may include other structures such as baffles 135 and or viscoelastic polyurethane foam. In other versions the inner core and sheath 120 are one component. In such a version, the material forming the supportive base 110 is constructed of a material that is not only impervious to fluid and resistant to puncture but is also configured to hold sufficient air pressure to support a desired sized animal and retain the desired rectangular cuboid shape. In one embodiment the supportive base 110 can support an animal as small as 11 pounds and in another can support an animal as large as one weighting 110 pounds with no loss in air pressure.

The supportive base 110 in yet another embodiment is configured to be self-inflating. While still a sealable component that can maintain a certain degree of air pressure, the internal structure 135 of the supportive base 110 enables it to self-expand and inflate with little to no user interaction. With minimal effort by a user, the supportive base 110 can be fully inflated and sealed, ready to be mated with the attachable cover 150. In another embodiment a pump can be attached to an inflation valve 115 to quickly inflate the supportive base 110 to its useable shape. In yet another embodiment a pump can be incorporated into the supportive base 110 itself. Upon release of the inflation value the base can begin self-inflating. The internal pump (not shown) can then be engaged to ether speed the inflation process or to supplement the self-inflation structure with additional pressure.

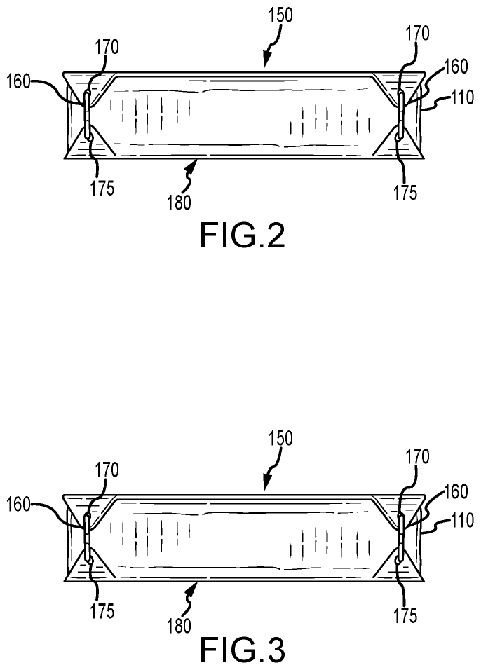

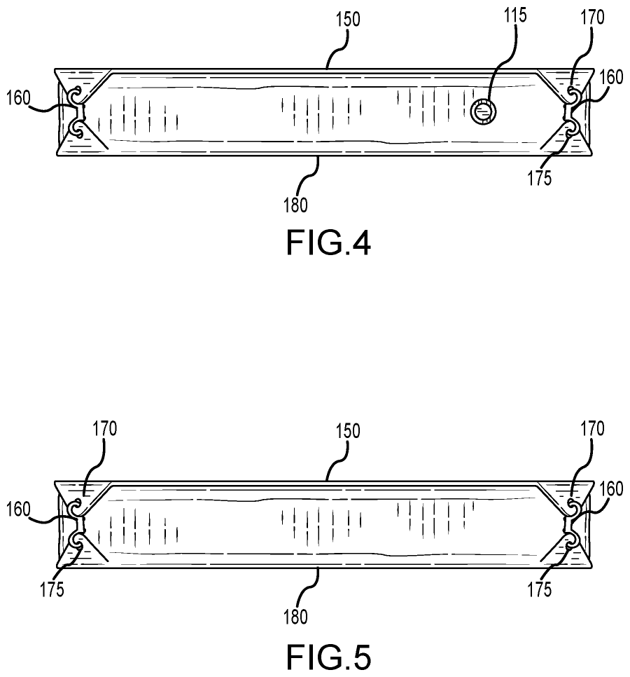

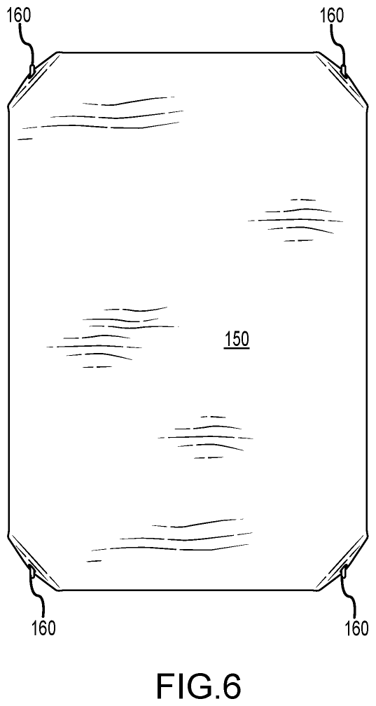

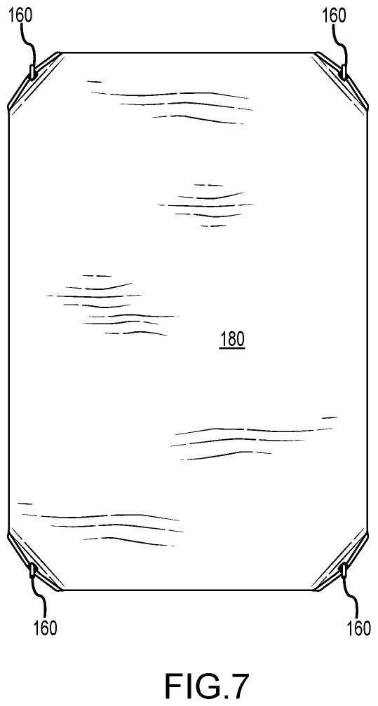

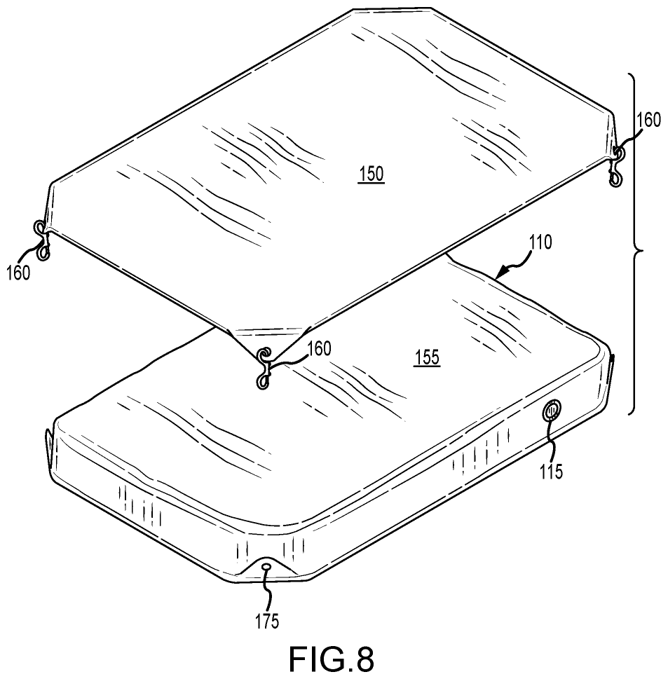

The supportive base 110, shown collectively in FIGS. 1-8, can be made of a variety of material that can hold a certain degree of air pressure. In one embodiment of the present invention, the supportive base 110 is configured to maintain between 0.1 and 2 pounds per square inch of internal pressure. Using a median number of 1 pounds per square inch and dimensions of a pet bed being 24 inches by 36 inches, or 836 square inches, the supportive bed can support even the largest pet. In the rare instance that the support base is subjected to an overpressure event, a pressure relieve valve 115 is include that releases excess pressure to prevent catastrophic damage to the supportive base 110. Upon release of the pressure the inflation value can be reopened and the baes re-inflated. The supportive base 110 and associated covers can come in variety of sizes (in inches) including 24×18 for animals between 11 and 25 lbs., 30×20 for animals between 26 and 40 lbs., 36×23 for animals between 41 and 75 lbs., and 42×28 for animals between 76 and 110 lbs.

Many inflatable devices such as pool floatation air mattresses, toys and camping grade air mattresses are constructed with PVC (polyvinyl chloride) plastic and contain many chemical additives. PVC is a known human carcinogen, is harmful to the environment, and likely harmful to animals. Thermoplastic Polyurethane (TPU) is a safer alternative to PVC plastic and is increasingly being used for medical applications and is bio-degradable-much better for our environment. Any TPU component that might be considered “dangerous” in its manufacture is rendered inert if successfully bonded. Accordingly, one embodiment of the present invention uses a TPU inflatable core for the supportive base 110. Other materials that are both capable holding the desire internal air pressure and be safe to the residents, be the human or animal, are compatible with the present invention.

The supportive base 110 is easily transported and easily cleaned. The inflatable nature of the supportive base 110 enables it to be deflated, folded, or rolled into a form factor many times smaller than its fully inflated shaped and transported to another location where it may again be inflated. In one version of the present invention straps are included that hold the deflated/compressed supportive base 110 in to is smallest form factor. Upon release, when self-inflating, the supportive base 110 reforms to its fully expanded shape at which point the inflation value is closed so that the shape can be retained.

As the supportive base 110 is impervious to fluids it is also easily cleaned. Upon removal of the cover 150 the base can be hosed down with water or emersed to remove any dirt or bacteria. The outer sheath 120 of the supportive base 110 is resistant to puncture from an animal's claws or teeth. While not indestructible, the supportive base 110 deters a pet from chewing or biting the bed or using its claws to dig and scratch, which would otherwise destroy the base.

One version of the cover 150 is an absorbent fabric or similar material that provides a durable yet inviting area on which the pet may rest. In this version the cover 150 is comprised of a fabric or material that is easily washable. In another version of the present invention the cover 150 is disposable made of cloth, fiber or similar material that upon becoming soiled, is discarded.

A reversible-fabric cover 150 envelopes the upper surface 155 of the inflatable base 110 and is secured on each of the four corners using a set of attachment devices 160. The attachment devices 160 prevent the cover 150 from shifting or the cover 150 from bunching which can result in holes and tears. In an alternative embodiment the invention eliminates the trigger clips, and rather adopts a fitted cover 150 let with straps or the like that extend under each corner or an elastic ring pulling the cover 150 taut under supportive base 110. Despite being fitted, the coverlet is still fastened to the bed, with, for example, elastic bands on the width of the coverlet.

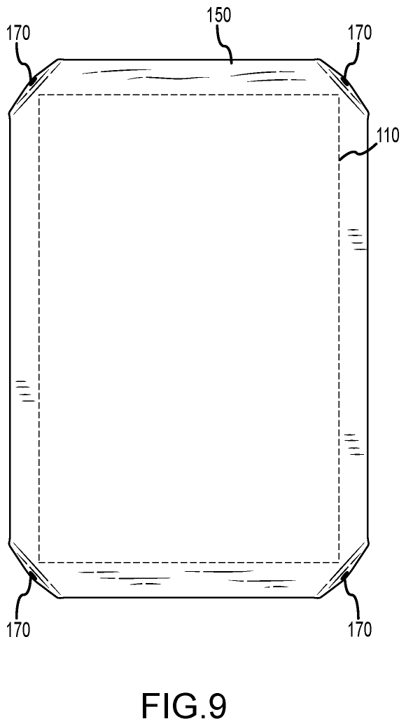

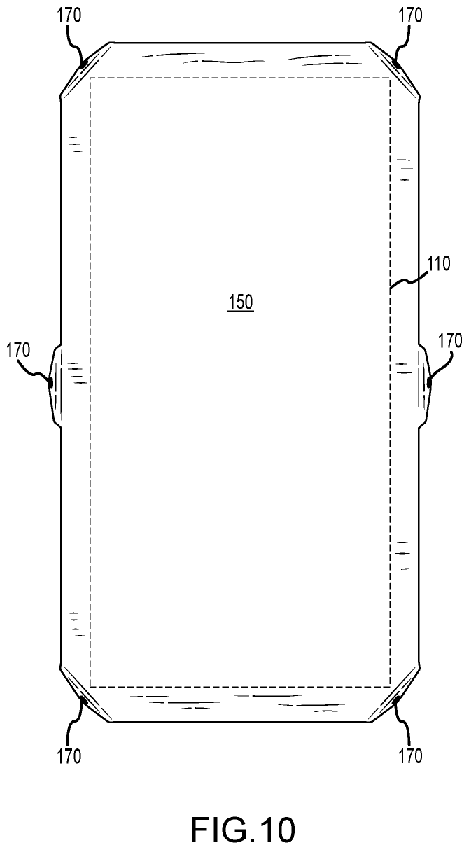

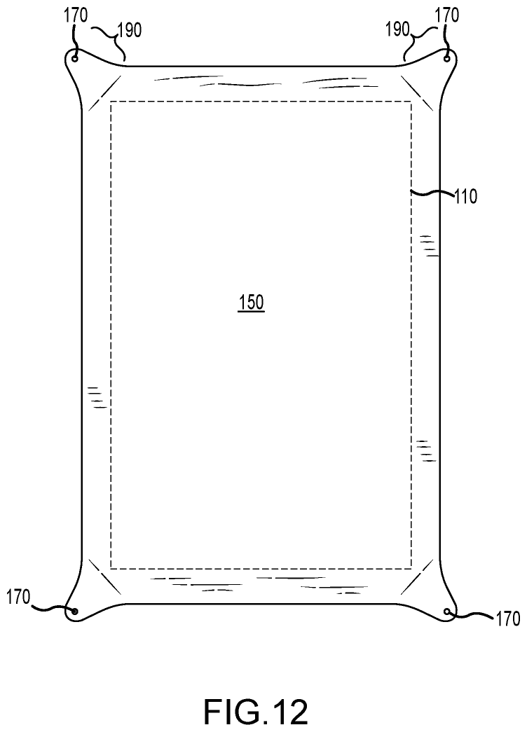

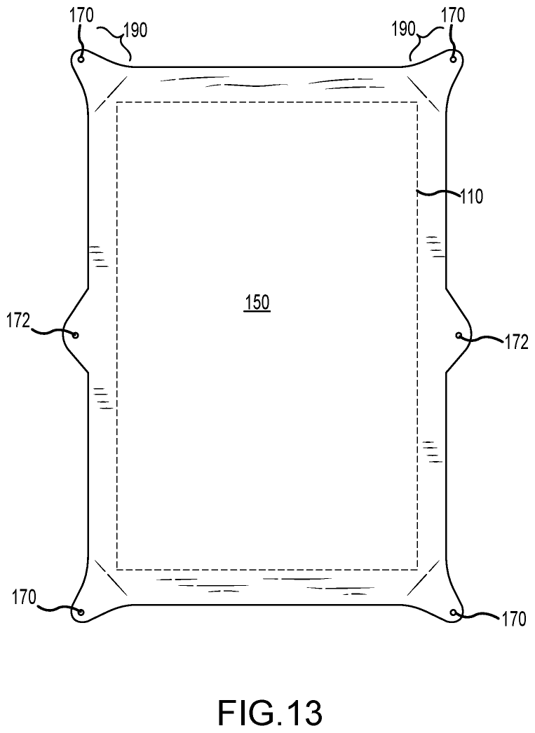

As shown in FIGS. 9, 10, 12 and 13, the cover 150 of the supportive base 110 is dimensioned to be slightly larger than that of the upper surface 155 so that upon being coupled to the base 110 the edges of the cover 150 drape over the edges of the supportive base 110. Each corner of the cover 150 is, in one embodiment, elongated and includes a reinforced grommet 170. In one version of the present invention the grommet 170 is a reinforced metal ring while in another it is a hole reinforce with a thread sew pattern. In larger version of the present invention the cover 150 may include mid-edge grommets 172 that correspond to mid-edge grommets in the lower edge of the supportive base 110.

Each grommet 170 of the cover 150 is matched with a corresponding grommet 175 extending from each corner of the lower surface of the supportive base 110. The grommet 175 from the lower surface of the support base and the grommet 170 of the corresponding corner of the cover 150 do not overlap. They are separated by a finite distinct spanned by an attachment device. Each attachment device 160, in one embodiment, includes a first movable attachment latch and second movable attachment latch separate by a connector. Each device 160 is configured to link the grommet 170 of the cover 150 to the grommet 175 associated with the lower surface 180 of the supportive base 110 by a finite separation distance, the separation distance being less than the width of the supportive base 110. In doing so the lower surface 180 of the supportive base 110 and the cover 150 are placed in tension on each corner, effectively stretching the cover 150 over the upper surface of the supportive base 110.

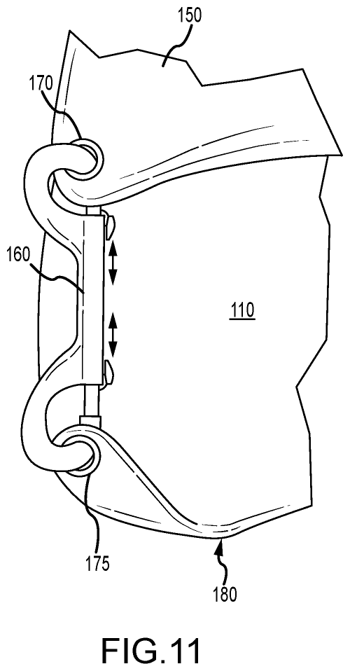

The attachment device 160 is, in one embodiment of the present invention, a double ended bolt snap hook or trigger as shown in FIG. 11. Each end is spring loaded to a closed position wherein upon translation of a latch on the trigger the corresponding hook opens. Upon being threaded through the grommet the latch is released closing the hook.

The span of the double ended bolt snap hook enables the supportive bed to retain its substantially rectangular cuboid shape. Moreover, the dual connectivity of the attachment device 160 enables the cover 150 to be easily removed, washed and returned to the base with minimal disruption. Other connective devices that can both link the cover 150 the lower surface while enabling the supportive base 110 to retain its shape are within the scope of the present invention and indeed contemplated. The attachment devices 160 including the double ended bolt snap hook can be formed from stainless steel, die-cast zinc, brass, or any other similar material. They may also be formed with certain thermoplastics provided they can retain and meet strength and rigidity requirements.

While there have been described above the principles of the present invention in conjunction with a modular pet bed, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se, and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

I claim:

1. A modular pet cushion system, comprising:
a supportive base encased with a protective sheath configured to be puncture resistant and impervious to fluids, wherein the supportive base is substantially a rectangular cuboid having an upper surface, a width, a lower surface and eight vertices, wherein each vertex associated the lower surface includes a base grommet;
a cover having four corners, wherein the cover includes a central portion sized to substantially match the upper surface of the supportive base and elongated portions at each corner and wherein each elongated portion includes a cover grommet; and
a set of attachment devices configured to connect each lower surface grommet with a cover grommet at each corner of the cover thereby removably securing the cover to the supportive base covering the upper surface.

2. The modular pet cushion system according to claim 1, wherein the supportive base is inflatable.

3. The modular pet cushion system according to claim 1, wherein the supportive base is self-inflatable.

4. The modular pet cushion system according to claim 1, wherein the supportive base includes an inflation valve.

5. The modular pet cushion system according to claim 1, wherein the supportive base includes internal viscoelastic polyurethane foam.

6. The modular pet cushion system according to claim 1, wherein the supportive base includes a pressure release valve.

7. The modular pet cushion system according to claim 1, wherein the supportive base includes a thermoplastic polyurethane core.

8. The modular pet cushion system according to claim 1, wherein the cover is absorbent.

9. The modular pet cushion system according to claim 1, wherein the cover is disposable.

10. The modular pet cushion system according to claim 1, wherein the cover is washable.

11. The modular pet cushion system according to claim 1, wherein the cover is reversable.

12. The modular pet cushion system according to claim 1, wherein each attachment device includes a first movable attachment latch and second movable attachment latch separated by a connector, wherein each attachment device is configured to link the cover to the lower surface of the supportive base by a separation distance, the separation distance being less than the width of the supportive base.

13. The modular pet cushion system according to claim 1, further comprising a pump configured to detachably couple with an inflation value associated with the supportive base.

14. A kit for a modular pet cushion, the kit comprising:
a supportive base encased with a protective sheath configured to be puncture resistant and impervious to fluids, wherein the supportive base is substantially an inflatable rectangular cuboid having an upper surface, a width, a lower surface and eight vertices, wherein each vertex associated the lower surface includes a base grommet and wherein the supportive base includes an inflation valve;
a cover having four corners, wherein the cover includes a central portion sized to substantially match the upper surface of the supportive base and elongated portions at each corner and wherein each elongated portion includes a cover grommet;
a set of attachment devices configured to connect each lower surface grommet with a cover grommet at each corner of the cover thereby removably securing the cover to the supportive base covering the upper surface; and
a pump configured to detachably couple with the inflation value of the supportive base.

15. The kit for a modular pet cushion according to claim 14, wherein each attachment device includes a first movable attachment latch and second movable attachment latch separate by connector, wherein each attachment device is configured to link the cover to the lower surface of the supportive base by a separation distance, the separation distance being less than the width of the supportive base.

16. The kit for a modular pet cushion according to claim 14, wherein the cover is absorbent.

17. The kit for a modular pet cushion according to claim 14, wherein the cover is disposable.

18. The kit for a modular pet cushion according to claim 14, wherein the cover is washable.

19. The kit for a modular pet cushion according to claim 14, wherein the cover is reversable.
